(19) United States
(12) Patent Application Publication
(10) Pub. No.: US 2022/0253231 A1
(43) Pub. Date: Aug. 11, 2022

(54) PROCESSING OF DATA STORED IN A MEMORY

(71) Applicant: Infineon Technologies AG, Neubiberg (DE)

(72) Inventors: Erich Wenger, Muenchen (DE); Steffen Sonnekalb, Muenchen (DE)

(21) Appl. No.: 17/577,471

(22) Filed: Jan. 18, 2022

(30) Foreign Application Priority Data
Feb. 5, 2021 (DE) 102021102777.2

(51) Int. Cl. G06F 3/06; G06F 21/56

(52) U.S. Cl. CPC G06F 3/0652; G06F 3/0673; G06F 3/0604; G06F 21/56

(57) ABSTRACT

Processing of data stored in a memory, wherein the data are deleted depending on a functional setting if an operation is performed on the data.

### FIELD OF THE DISCLOSURE

The invention relates to the processing of data depending on different operating modes.

### BACKGROUND

A side-channel attack designates a cryptoanalytical method which utilizes the physical implementation of a cryptosystem in a device (e.g. a chip card, a security token or a hardware security module) or in a software package. Only a specific implementation, rather than the cryptographic method itself, is attacked. Details can be found, for example, at https://de.wikipedia.org/wiki/Seitenkanalattacke. An attacker can, for example, exploit the fact the power consumption of a device can be proportional to the processed data.

Software with protection against side-channel attacks often requires processing in two parts (referred to as shares), wherein it is intended to be ensured that the two parts do not collide in the same hardware component, e.g. are processed jointly there. Such a collision of the two parts in a hardware component could possibly result in the power consumption being proportional to the secret value. Protection against side-channel attacks would therefore be largely ineffective.

### SUMMARY

The object of the invention is to overcome the above-mentioned disadvantages and improve security against side-channel attacks.

This object is achieved according to the features of the independent claims. Preferred embodiments can be found, in particular, in the dependent claims.

To achieve the object, a method is proposed for processing data stored in a memory,
in which the data are deleted depending on a functional setting if an operation is performed on the data.

The data can be deleted here depending on the functional setting in particular while an operation is being (at least partially) performed on the data or if an operation will be performed.

The functional setting determines whether the data in the memory are or are not deleted.

The deletion can be performed on memories or registers which are visible to the outside or are not visible from the outside. Memories of this type which are not visible from the outside are also referred to as non-architectural memories which are, for example, permanently assigned to a processing unit (for example internal registers of a CPU).

Non-architectural memories can be deleted, for example, by means of the approach proposed here without a programmer having to take charge of a deletion of this type (which he would also not be capable of doing due to the nature of the system).

The data can involve one value or a plurality of values. The memory can comprise a register into which a value of this type is loadable from a further memory. The operation can be a logical operation which is performed on this value. It is also possible for a plurality of values to be loaded into a plurality of registers and for the operation to be performed on this plurality of values (data) by linking the values with one another. The operations can involve a shift operation or a Boolean operation. The operation can essentially comprise a plurality of operands, wherein each operand can be one of the values or a constant.

The deletion preferably involves a procedure which can be activated by means of the functional setting depending on a predefined security setting or security requirement. It is thus guaranteed that, following each operation on the data, the data temporarily stored in the memory are again actively deleted. A successful side-channel attack, for example, aimed at this memory is therefore effectively prevented, since the data are retained for a short time only in order to perform the operation in the memory.

The deletion can comprise, for example: an overwrite with a predefined value, an overwrite with a random or pseudorandom value, an overwrite with a value for which a downstream error correction cannot perform a correction, a predefined set of “0” or “1” values, etc.

In one development, the memory comprises at least one register or a cache memory and the data correspond to a value loadable into the memory.

In one development, the data are deleted by means of at least:
one constant,
one random value,
one pseudorandom value.

In one development, the data are deleted depending on the functional setting after the operation has been performed on the data, while the operation is being performed on the data and/or before the operation is performed on the data.

In one development, the memory comprises at least one of the following components:
a register,
a memory not accessible or not visible from outside in relation to a processing unit,
a memory accessible or visible from outside in relation to a processing unit,
a RAM,
a non-volatile memory,
a cache memory.

In one development, the method is carried out on at least one of the following components:
a processing unit,
a processor unit, in particular a CPU,
a controller,
an arithmetic logic unit, ALU,
a cache memory,
a security module,
a crypto unit,
a coprocessor.

In one development, the deletion is initiated and/or performed by a hardware component.

In particular, the deletion (deletion procedure) can be a deletion initiated by the hardware component which comprises, for example, a reset and/or overwrite of the data stored in the memory. The functional setting thus determines whether a hardware-initiated deletion is or is not intended to be performed.

The deletion procedure itself can similarly be performed by the hardware component.

The hardware component can preferably be a processing unit (e.g. processor, microcontroller) on which or by which the steps of the method are carried out.

In one development, a security mode is activatable or deactivatable by means of the functional setting.

The functional setting can be influenceable by a switch or by a plurality of switches, e.g. flags. In particular, a switching mimic can be provided which is activatable or deactivatable. This can be implemented by means of at least one functional switch. The functional switch can be implemented, for example, by means of a (further) register or by means of an operation code of a program.

In one development, the security mode is activatable or deactivatable depending on at least one of the following criteria:
a predefined setting,
a jump to an exception routine,
a return from an exception routine,
a call of a function,
a return from a function,
an address range or program area that is used or to be used,
a crypto unit that is used,
an input/output unit,
an instruction or a set of instructions,
a position of a program pointer,
a position of a stack pointer.

The exception routine can be an interrupt or a trap.

The functional setting can also be triggered (activated and/or deactivated) by a predefined condition: An address range, a crypto unit, a program area, an instruction (operation code) or a set of instructions, a position of a program pointer or stack pointer, for example, can determine the functional setting in such a way that the security mode is thereby activated or deactivated.

In one development, the security mode is activatable or deactivatable depending on the involvement of at least one of the following components:
a switch,
a register,
a configuration register,
a crypto unit,
an input/output unit,
a processing unit,
a processor unit, in particular a CPU,
a controller,
an arithmetic logic unit, ALU,
a cache memory,
a security module,
a coprocessor.

In one development, the security mode has a plurality of deletion stages.

One from a plurality of deletion stages can be determined, for example, by means of the functional setting or by means of further parameters (e.g. depending on the above-mentioned criteria).

In particular, at least one of the following deletion stages is possible depending on the mode and/or depending on the memory or a part of the memory:
the deletion is always performed,
the deletion is never performed,
the deletion is performed before an operation,
the deletion is performed after an operation,
the deletion is performed for at least one predefined resource.

In one development, the deletion is performed after each operation, provided that the security mode is activated.

In one development, the deletion is performed after at least one cycle duration of a clock signal and/or after a predefined time duration.

In one development, the data have previously been read from a further memory and loaded into the memory.

The further memory can be any memory to which a processing unit, e.g. a processor or microcontroller, has access.

A device is also proposed for processing data,
having at least one memory,
wherein the device is configured in such a way that the data in the at least one memory or a part of the at least one memory are deleted depending on a functional setting if an operation is performed on the data.

In one development, the device comprises a processing unit, in particular a processor or a microcontroller.

The processing unit specified here can be designed, in particular, as a processor unit and/or an at least partially hardwired or logical circuit arrangement which is configured, for example, in such a way that the method as described herein can be carried out. Said processing unit may be or may comprise any type of processor or calculator or computer with correspondingly necessary peripherals (memory, input/output interfaces, input/output devices, etc.).

The explanations above relating to the devices apply accordingly to the method. The respective device can be implemented in one component or can be distributed among a plurality of components.

In one development, the memory comprises at least one of the following components:
a register,
a memory not accessible or not visible from outside in relation to a processing unit,
a memory accessible or visible from outside in relation to a processing unit,
a RAM,
a non-volatile memory,
a cache memory.

In one development, the device further comprises a main memory, wherein the device is configured to load the data from the main memory into the at least one memory.

The main memory can be any memory, in particular a RAM, ROM, external memory (cloud) or the like.

In one development, the device is operable by means of the functional setting in a power-optimized mode or in a security-optimized mode, wherein, in the security-optimized mode, the data in the at least one memory or a part of the at least one memory are deleted if the operation is performed on the data.

The power-optimized mode optionally also comprises a performance-optimized mode.

In one development, the data in the at least one memory or a part of the at least one memory are actively deleted by the device.

### BRIEF DESCRIPTION OF THE DRAWING

The characteristics, features and advantages described above and the manner in which they are achieved will be further explained in detail in conjunction with the following schematic description of example embodiments which are explained with reference to the drawing.

In the drawing:

FIG. 1 shows a schematic diagram to illustrate the processing of values temporarily stored in registers.

### DETAILED DESCRIPTION

An operating mode for a processing unit (e.g. a processor or a microcontroller) which reduces, limits or avoids data collisions within the processing unit is proposed here by way of example. It is thereby possible for side-channel attacks to be efficiently impeded which are aimed at the determination of a power consumption for two consecutive instructions (e.g. commands of a program). If a register is used to store data, this register can be deleted, for example, if it is not required by the following instruction. In other words, temporarily stored data can be deleted whenever they are no longer required, in particular by an immediately following instruction. Retention of data in memories (e.g. registers) for longer than necessary is thereby prevented, for example, and the effectiveness of said data for a successful side-channel attack is therefore restricted.

In particular, a targeted deletion of memories is proposed. A deletion of this type requires electrical energy and is frequently avoided wherever possible in the context of a power-optimized circuit design.

A functional setting is proposed, e.g. as a mode switch, for example in the form of a mode bit, by means of which a switchover between a power-optimized mode and a security-optimized mode can be implemented. The security-optimized mode can thus be activated if required. As explained above, side-channel attacks are effectively impeded in the security-optimized mode.

A targeted deletion of (for example temporary) memories, e.g. memory cells, registers or other memory elements, can be performed in the security-optimized mode. Memories of this type contain, for example, interim results. There is therefore no delay in the security-optimized mode until such a memory is overwritten or in establishing whether a memory of this type is overwritten, but instead a deletion of the memory is instigated in a targeted manner. This can provide an incentive to retain the data in the memory for the shortest possible time only, and then to delete said data without delay. The risk of a collision of parts, i.e. of temporarily stored data, within an individual hardware component is thereby reduced.

The deletion is preferably initiated and/or performed by the hardware component. Such a deletion can be performed in different (security) stages. A repeated overwrite, for example, with one or more predefined values (which differ from secret data) can guarantee that the secret data are increasingly poorly determinable by means of an attack.

By means of the examples explained here, it is possible to provide program code which has a targeted protection against site-channel attacks: the hardware behaves predictably, i.e. there are no code optimizations which leave individual data undeleted in memory cells if the security-optimized mode is active. A developer does not therefore have to guarantee a secure implementation of his program code which is possibly present in a high-level language. Instead, the programmer (if he activates the security-optimized mode) can rely on the implementation (e.g. by means of a compiler) ensuring that individual data in the memory are deleted as quickly as possible. This further offers the advantage that the software itself requires no additional measures against side-channel attacks since the implementation guarantees in the security-optimized mode that an active deletion is performed and side-channel attacks are hindered. This in turn offers the advantage that the software itself requires fewer revisions (redesign).

A secret A, for example, can be divided into parts (“shares”) A0 and A1. A0 can be a mask and A1 can be a masked datum. As a result of an exclusive-or operation (XOR operation), abbreviated here as “+”, the secret A is defined as follows:

A=A0+A1.

The parts A0 and A1 are not intended to collide within a hardware component in order to avoid discovery of the secret A by means of a side-channel attack.

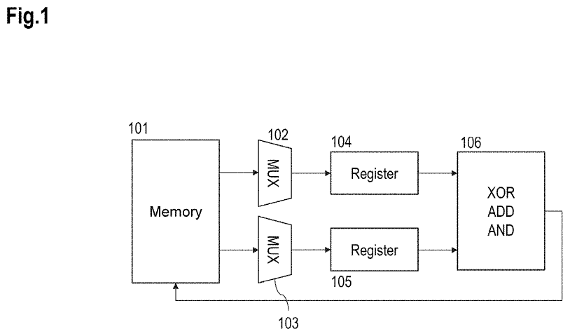

FIG. 1 shows an example of a block diagram which illustrates steps of the approach presented here. Steps of this type can be executed on a processing unit which has at least one processor and/or at least one microcontroller.

A multiplexer 102 accesses a memory 101 and stores a value A0 in a register 104. A multiplexer 103 accesses the memory 101 and stores a value A1 in a register 105. A processing unit 106 executes, by way of example, an XOR operation, wherein the two values stored in the registers 104 and 105 are not intended to collide:

A=A0+A1

and stores the result A of this XOR operation in the memory 101.

Once the XOR operation has been executed, the values A0 and A1 are still present in the registers 104 and 105. This may have no further significance in the power-optimized mode, but if the security-optimized mode is activated, it is ensured that at least one of the registers 104, 105 is deleted following the execution of the XOR operation. It is assumed below by way of example that the security-optimized mode is active and that both registers 104, 105 are deleted.

It is possible, for example, for a delete procedure to be automatically initiated for the registers 104, 105 as soon as the processing unit 106 has performed the XOR operation. At least one cycle duration of a clock signal or a part of the cycle duration of the clock signal can be provided for the delete procedure itself. The delete procedure can be performed, for example, by the hardware component and can comprise an overwrite with at least one predefined value, e.g. a constant (e.g. zero) or a random value (e.g. a pseudorandom value). In particular, the delete procedure is a physical delete procedure which resets and/or actively overwrites the value stored in the registers 104, 105.

In one particular option, an operation which follows the XOR operation cited here by way of example initiates the delete procedure for the registers 104, 105. The trigger for the delete operation can, for example, be a clock signal which follows the XOR operation.

A further option comprises a delay for a predefined time duration, e.g. a predefined number of cycle durations of the clock signal (or an absolute predefined time duration independent from the clock signal) before the registers 104, 105 are deleted. A delay of this type can temporally follow the writing of the registers 104, 105, the reading of the registers 104, 105 or the performance of the XOR operation. In this sense, different temporally initiating events (triggers) are possible.

One option comprises deleting only one of the registers 104, 105. In accordance with a reduced security requirement, for example, all registers do not need to be deleted. According to the present approach, if a multiplicity of registers are provided, only a single register, a subset of a plurality of registers or all registers can be deleted following the operation executed by the processing unit 106.

In a further option, the same registers are always deleted or different registers are deleted after each operation.

The processing unit 106 executes the XOR operation here by way of example. The processing unit 106 can correspondingly execute other operations also, e.g. an addition (ADD), an OR operation (OR), an AND operation (AND), a shift operation, etc. According to one variant, one of the values A0 or A1 can be a constant. A command:
“ADD A0, 5”,
   thus determines that the value A0 is loaded from the memory into the register 104, and the constant value 5 is loaded into the register 105. The processing unit 106 performs an addition of the value A0 with the constant 5. In one particular option, the delete procedure explained above is applied to the register 104 only, but not to the register 105.

The delete operation can therefore also depend, for example, on whether a value has previously been loaded from the memory into the register that is to be deleted.

It should additionally be noted that any combinations of the events initiating the delete procedure which are described here are possible as a trigger for the execution of the delete procedure.

Although the invention has been illustrated and described in greater detail by means of the at least one example embodiment shown, the invention is not limited thereto and other variations may be derived therefrom by the person skilled in the art without departing the protective scope of the invention.

1. A method for processing data stored in a memory,
wherein the data are deleted depending on a functional setting if an operation is performed on the data.

2. The method as claimed in claim 1, wherein the memory comprises at least one register or a cache memory, and the data correspond to a value loadable into the memory.

3. The method as claimed in claim 1, wherein the data are deleted by means of one constant, one random value, or one pseudorandom value.

4. The method as claimed in claim 1, wherein the data are deleted depending on the functional setting after the operation has been performed on the data, while the operation is being performed on the data, and/or before the operation is performed on the data.

5. The method as claimed in claim 1, wherein the memory comprises a register, a memory not accessible or not visible from outside in relation to a processor, a memory accessible or visible from outside in relation to a processor, a RAM, a non-volatile memory, or a cache memory.

6. The method as claimed in claim 1, wherein the method is carried out on a processor, a CPU, a controller, an arithmetic logic unit (ALU), a cache memory, a security module, a crypto unit, or a coprocessor.

7. The method as claimed in claim 1, wherein the deletion is initiated and/or performed by a hardware component.

8. The method as claimed in claim 1, wherein a security mode is activatable or deactivatable by means of the functional setting.

9. The method as claimed in claim 8, wherein the security mode is activatable or deactivatable depending on a predefined setting, a jump to an exception routine, a return from an exception routine, a call of a function, a return from a function, an address range or program area that is used or to be used, a crypto unit that is used, an input/output unit, an instruction or a set of instructions, a position of a program pointer, or a position of a stack pointer.

10. The method as claimed in claim 8, wherein the security mode is activatable or deactivatable depending on a switch, a register, a configuration register, a crypto unit, an input/output unit, a processor, a CPU, a controller, an arithmetic logic unit (ALU), a cache memory, a security module, or a coprocessor.

11. The method as claimed in claim 8, wherein the security mode has a plurality of deletion stages.

12. The method as claimed in claim 8, wherein the deletion is performed after each operation, provided that the security mode is activated.

13. The method as claimed in claim 12, wherein the deletion is performed after at least one cycle duration of a clock signal and/or after a predefined time duration.

14. The method as claimed in claim 1, wherein the data have previously been read from a further memory and loaded into the memory.

15. A device for processing data, comprising:
at least one memory,
wherein the device is configured in such a way that the data in the at least one memory or a part of the at least one memory are deleted depending on a functional setting if an operation is performed on the data.

16. The device as claimed in claim 15, wherein the device comprises a processor or a microcontroller.

17. The device as claimed in claim 15, wherein the memory comprises a register, a memory not accessible or not visible from outside in relation to a processor, a memory accessible or visible from outside in relation to a processor, a RAM, a non-volatile memory, or a cache memory.

18. The device as claimed in 15, further comprising a main memory, wherein the device is configured to load the data from the main memory into the at least one memory.

19. The device as claimed in claim 15, wherein the device is operable by means of the functional setting in a power-optimized mode or in a security-optimized mode, and, in the security-optimized mode, the data in the at least one memory or a part of the at least one memory are deleted if the operation is performed on the data.

20. The device as claimed in claim 15, wherein the data in the at least one memory or a part of the at least one memory are actively deleted by the device.
